(19) United States
(12) Patent Application Publication
(10) Pub. No.: US 2014/0042159 A1
(43) Pub. Date: Feb. 13, 2014

(54) MODULAR LAYER HORIZONTAL STORAGE MODULE AND METHODS OF MANUFACTURING SAME

(71) Applicant: Transnuclear, Inc., Columbia, MD (US)

(72) Inventor: Ahmad E. Salih, Columbia, MD (US)

(73) Assignee: TRANSNUCLEAR, INC., Columbia, MD (US)

(21) Appl. No.: 13/965,046

(22) Filed: Aug. 12, 2013

Related U.S. Application Data
(60) Provisional application No. 61/682,696, filed on Aug. 13, 2012.

(51) Int. Cl. B65D 13/00; B65D 90/02; B29D 22/00

(52) U.S. Cl. CPC B65D 13/00; B29D 22/003; B65D 90/02
USPC 220/4.01; 264/250

(57) ABSTRACT

A horizontal storage module (HSM) assembly generally includes a base portion including a plurality of segments that are vertically layered on top of each other and a lid portion. A method of constructing an HSM assembly generally includes forming a plurality of segments for the base portion of the HSM assembly, and vertically stacking the segments.

### CROSS-REFERENCE TO RELATED APPLICATION

This application claims the benefit of U.S. Provisional Application No. 61/682696, filed Aug. 13, 2012, the disclosure of which is expressly incorporated by reference herein in its entirety.

### BACKGROUND

Horizontal storage modules (HSMs) are typically used for the dry storage and containment of radioactive materials in ventilated canister storage systems at reactor or other storage sites. Previously designed HSMs are generally manufactured from reinforced concrete as a single base unit with an attachable lid. These HSMs may have dimensions of about 18-20 feet in height, by about 8-10 feet in width and about 20-22 feet in length. The weight of these single base unit HSMs can be around 320,000 lbs (unloaded).

HSM units are typically constructed at a manufacturing site in two pieces (base and lid), then the pieces are shipped to a reactor or storage site for use. Due to shipping regulations, single base unit HSMs must be shipped by rail or barge because they are too heavy and too large to be shipped by truck. In view of the size and weight, the shipping costs for such large, heavy single base unit HSMs have become very high and, in some cases, cost prohibitive.

To solve the shipping problem, there exists a need for modular HSMs that can be shipped in parts, then easily reassembled on site. However, designers have been hesitant to develop modular HSMs in the past because of concerns regarding inferior structural integrity, thereby requiring regular maintenance checks and causing inconvenience to the HSM users. Therefore, there exists a need for modular HSMs having improved structural integrity. Embodiments of the present disclosure are directed to fulfilling this and other needs.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one embodiment of the present disclosure, an HSM assembly is provided. The assembly generally includes a base portion including a plurality of segments that are vertically layered on top of each other, and a lid portion.

In accordance with another embodiment of the present disclosure, a method of constructing an HSM assembly is provided. The method generally includes forming a plurality of segments for the base portion of the HSM assembly, and vertically stacking the segments.

In accordance with any of the embodiments described herein, the base portion may include at least first and second segments.

In accordance with any of the embodiments described herein, the base portion may include at least first, second, and third segments.

In accordance with any of the embodiments described herein, the plurality of segments may be substantially similar in at least one of size, shape, and weight.

In accordance with any of the embodiments described herein, adjacent segments may be attached to one another using a vertical attachment system.

In accordance with any of the embodiments described herein, the vertical attachment system may include a plurality of vertically oriented holes in the sidewalls of adjacent segments, and ties connecting such holes.

In accordance with any of the embodiments described herein, the plurality of segments may be made from reinforced concrete.

In accordance with any of the embodiments described herein, adjacent segments may be attached to one another using only a vertical attachment system.

In accordance with any of the embodiments described herein, the plurality of segments may be formed in a single form.

In accordance with any of the embodiments described herein, the first segment may be poured and allowed to harden, and the second segment may be poured on the hardened first segment.

In accordance with any of the embodiments described herein, the second segment is allowed to harden, and the third segment is poured on the hardened second segment.

In accordance with any of the embodiments described herein, the plurality of segments may include bond breakers between adjacent segments in the form.

In accordance with any of the embodiments described herein, a method of construction may further include vertically attaching adjacent segments.

In accordance with any of the embodiments described herein, a method of construction does not include horizontally attaching adjacent segments.

In accordance with any of the embodiments described herein, the plurality of segments may be stacked using a single lifting fixture.

### DESCRIPTION OF THE DRAWINGS

The foregoing aspects and many of the attendant advantages of this disclosure will become more readily appreciated as the same become better understood by reference to the following detailed description, when taken in conjunction with the accompanying drawings, wherein:

FIG. 1 is an isometric view of a modular layer horizontal storage module (HSM) assembly in accordance with one embodiment of the present disclosure;

FIG. 2 is an exploded view of the modular layer HSM assembly of FIG. 1;

FIG. 3 is a front view of the modular layer HSM assembly of FIG. 1;

FIG. 4 is a side view of the modular layer HSM assembly of FIG. 1; and

FIG. 5 is an isometric view of a previously designed HSM.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result.

In the following description, numerous specific details are set forth in order to provide a thorough understanding of exemplary embodiments of the present disclosure. It will be apparent to one skilled in the art, however, that many embodiments of the present disclosure may be practiced without some or all of the specific details. In some instances, well-known process steps have not been described in detail in order not to unnecessarily obscure various aspects of the present disclosure. Further, it will be appreciated that embodiments of the present disclosure may employ any combination of the features described herein.

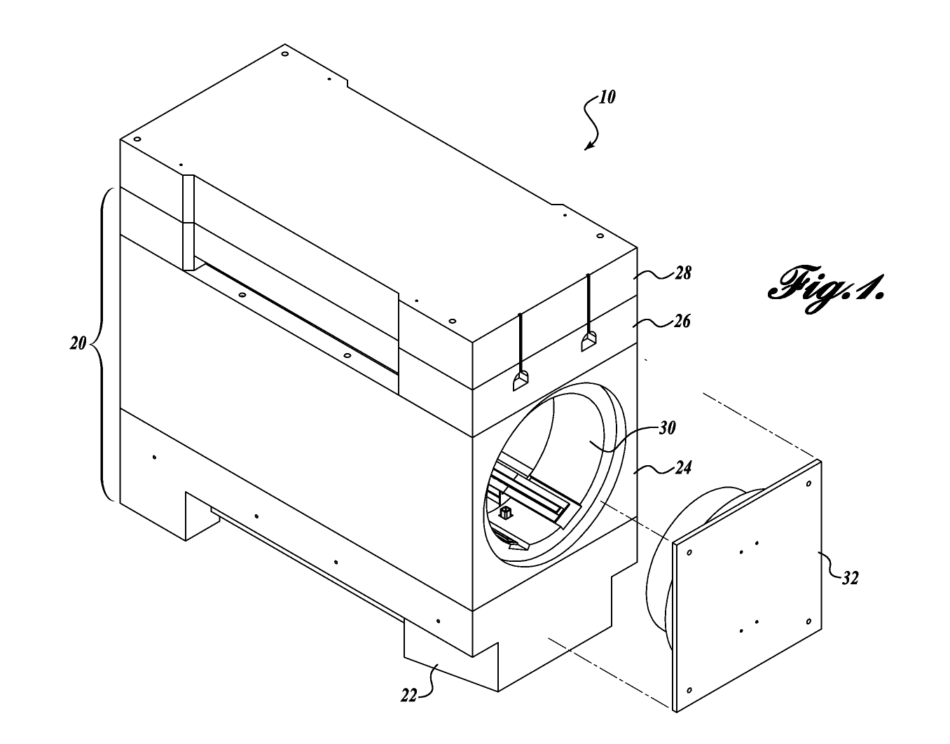

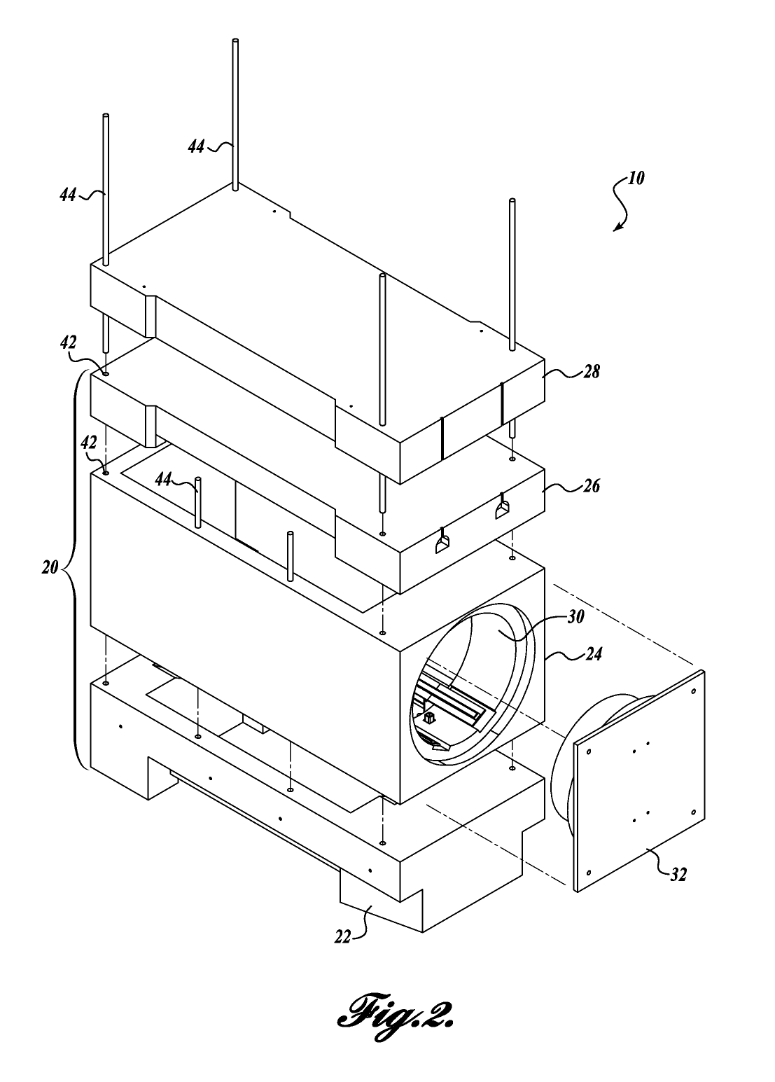

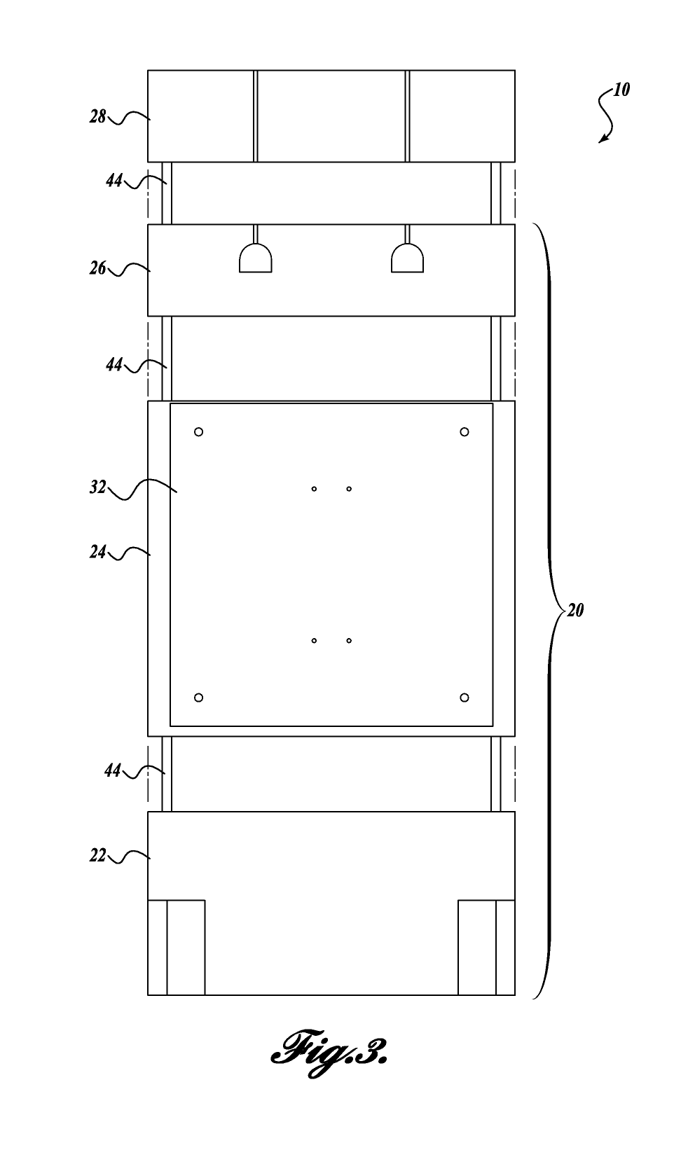

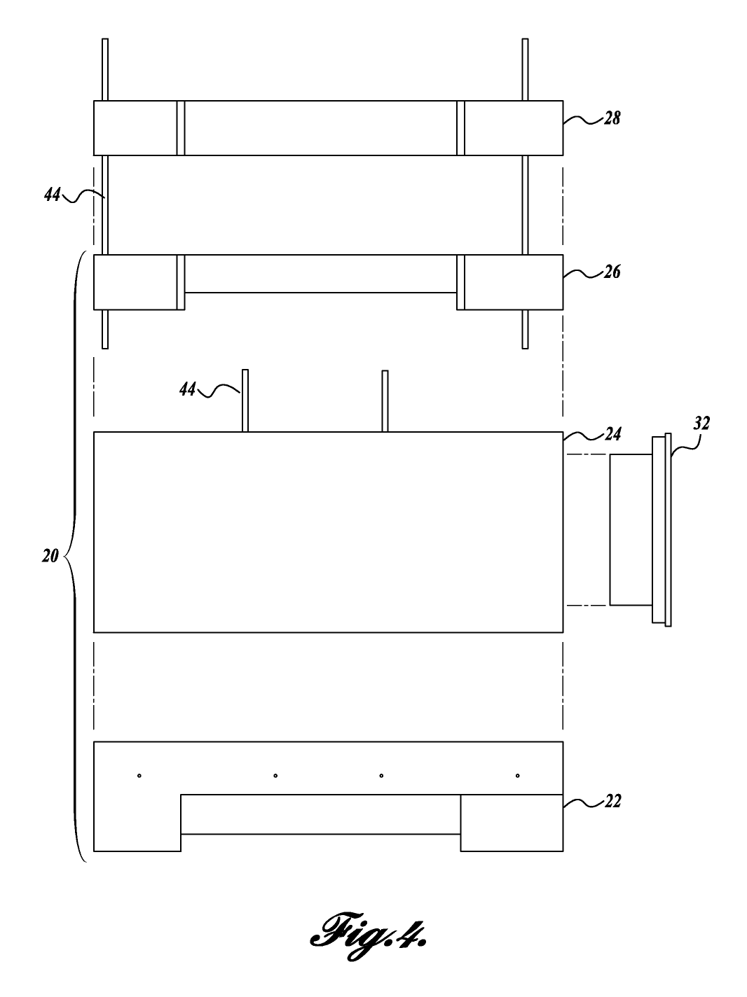

Embodiments of the present disclosure are directed to horizontal storage module (HSM) assemblies, for example, used for the dry storage and containment of radioactive materials in ventilated canister storage systems having modular constructions, and methods of manufacturing the same. Referring to FIGS. 1-4, a modular layer HSM assembly 10 constructed in accordance with one embodiment of the present disclosure is provided. The modular layer HSM assembly 10 includes a base portion 20 having a plurality of segments or layers 22, 24, 26 that can be vertically stacked on top of one another, and a separate lid 28. Such vertical stacking construction employs a vertical attachment system, as is described in greater detail below.

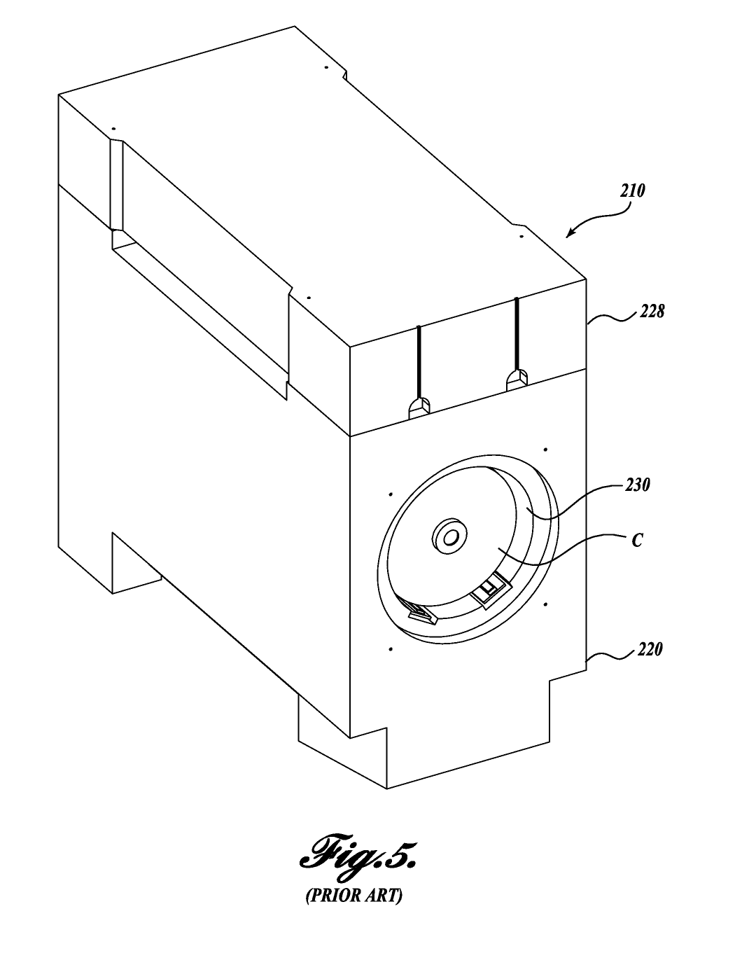

Referring to FIG. 5, a previously designed single base unit HSM 210 is provided. Like a modular layer HSM assembly 10, a previously designed HSM 210 is generally manufactured from reinforced concrete. The HSM 210 includes a base 220 for receiving a canister C containing radioactive materials. In that regard, the HSM 210 includes a front entry hole 230, and an internal chamber designed for supporting a container. A shield door (not shown) can be used to close the front entry hole 230 of the HSM 210 after a canister C has been received. A lid 228 is manufactured separately from the base 220 and placed on top of the base 220 when assembled on site for use.

Previously designed HSMs 210 are generally designed with enhanced radioactive shielding performance, seismic capabilities, heat rejection capabilities, and ruggedness for resisting acts of sabotage. Moreover, previously designed HSMs 210 are fabricated off-site so as to not require any major construction at the containment site. Embodiments of the present disclosure directed to modular layer HSM assemblies are also designed to meet these criteria.

As a non-limiting example, a standard HSM has a height of about 222 inches (18.5 feet), with the base portion having a height of about 178 inches (14 feet, 10 inches) and the lid portion having a height of about 44 inches (3 feet, 8 inches). Because of these large dimensions, the forming of the concrete forms for the base portion is complex. In that regard, large metal forms for forming the base portion are heavily stiffened to accommodate the high hydrostatic pressure within the forms. Despite heavy stiffening, deflection problems are often encountered with these forms as a result of the high hydrostatic pressure in the forms. Moreover, replacement of these forms is expensive as a result of the heavy stiffening required.

Returning to FIGS. 1-4, the modular layer HSM assembly 10 designed in accordance with one embodiment of the present disclosure has a base portion 20 having a segmented design. In that regard, the base portion 20 includes individual segments 22, 24, 26 that can be vertically stacked on top of one another, and a lid portion 28 is designed and configured to stack on top of the base portion 20. In the illustrated embodiment, the base portion 20 is divided into three segments; however, it should be appreciated that any number of segments are within the scope of the present disclosure.

In the illustrated embodiment of FIGS. 1-4, the three segments 22, 24, and 26 of the base portion 20 have divisions between segments in horizontal planes occurring above and below the front entry hole 30. Therefore, the segmentation does not divide the front entry hole 30 or the internal chamber that is designed to support a container. In one embodiment of the present disclosure, the segments 22, 24, and 26 are substantially similar in at least one of size, shape, and weight. The term “substantially” is used herein to be within an acceptable range of engineering tolerance in the industry. It should be appreciated, however, that other vertical segmentation so that the segments 22, 24, and 26 are not substantially similar in at least one of size, shape, and weight is also within the scope of the present disclosure.

In accordance with one embodiment of the present disclosure, a method of manufacturing the segmented base portion 20 will now be described. Like the previously designed HSM 210, described above, the modular layer HSM assembly 10 is constructed using reinforced concrete that is poured in a single form. The first segment 22 of the base section 20 is poured into the form, and allowed to harden. Thereafter, the second segment 24 of the base section 20 is poured into the form on top of the hardened first segment 22. Subsequently, the third segment 26 is poured into the form on top of the hardened second segment 24. The lid 28 may be formed separately, or may be formed on top of on top of the hardened third segment 26.

By casting subsequent layers against a hardened previous layer, the joints are almost invisible when the segments 22, 24, and 26 are reassembled during the assembly of the HSM assembly 10 at the site of use. A bond breaker can be applied to each hardened segment before the subsequent segment is poured to ensure that the segments will separate. This process is called match casting and is widely used in the pre-cast industry.

Other casting techniques may also be used to ensure a good fit between segments 22, 24, and 26. For example, the individual segments may be cast in separate forms with special attention to dimensional control of the matching faces and shear keys. Because of casting in multiple segments 22, 24, and 26, the hydrostatic pressure in the segments is substantially decreased in a linear relation to the segment height, as compared to a single base unit HSM 210 (as described above and as can be seen in FIG. 5). As the hydrostatic pressure is reduced, the potential for dimensional deviation in the segments 22, 24, and 26 is significantly reduced. As a non-limiting example, for a three-segment concept, the hydrostatic pressure in each segment may be decreased in a linear relation to segment height to be approximately ⅓ of the hydrostatic pressure in a comparable single base unit HSM 210. Likewise, for a two-segment concept, the hydrostatic pressure in each segment may be decreased to be approximately ½ of the hydrostatic pressure in a comparable single base unit HSM 210.

Moreover, the forms for manufacturing the modular layer HSM assembly 10 are less expensive and more reliable because they are not required to be stiffened for handling the height requirements of a comparable single base unit HSM 210.

Although described as using a single form, it should be appreciated that the use of multiple forms for the various different segments of the base portion 20 is also within the scope of the present disclosure.

After forming, the segments 22, 24, and 26 of the base portions 20 are individually shipped to the reactor or storage site. Segment shipping significantly reduces the size and weight of components shipped, and thereby improves the ease of shipping.

At the user's site, the segments 22, 24, and 26 of the base portion 20 can be vertically stacked on top of each other and secured using an attachment system. The segments may be substantially similar to one another in size, shape, and placement during assembly; therefore, one lifting fixture can be employed for assembling the various layers of the modular layer HSM, further reducing assembly cost and complexity.

Because the segments 22, 24, and 26 of the base portion 20 vertically stack on top of each other, the modular layer HSM assembly 10 can rely on gravity and friction between the segments to maintain the base portion 20 construction. In addition to gravity and friction, the base portion 20 can be further secured with a vertical attachment system, and therefore, avoids using a horizontal attachment system, such as a post tension system. A modular layer HSM assembly 10 having vertical connections between segments has more structural integrity than can be seen in modular assemblies that include horizontal attachment systems.

A suitable vertical attachment system may include holes 42 in the sidewalls of the adjacent various segments 22, 24, and 26 that are joined using ties 44, such as rebar ties, which are then grouted in place in the holes. The holes 42 may be formed during the molding process, or may be drilled after forming. It should be appreciated that other vertical attachment systems are also within the scope of the present disclosure.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

1. An HSM assembly, comprising,
(a) a base portion including a plurality of segments that are vertically layered on top of each other; and
(b) a lid portion.

2. The assembly of claim 1, wherein the base portion includes at least first and second segments.

3. The assembly of claim 1, wherein the base portion includes at least first, second, and third segments.

4. The assembly of claim 1, wherein the plurality of segments are substantially similar in at least one of size, shape, and weight.

5. The assembly of claim 1, wherein adjacent segments are attached to one another using only a vertical attachment system.

6. The assembly of claim 5, wherein the vertical attachment system includes a plurality of vertically oriented holes in the sidewalls of adjacent segments, and ties connecting such holes.

7. The assembly of claim 1, wherein the plurality of segments are made from reinforced concrete.

8. A method of constructing an HSM assembly, the method comprising:
(a) forming a plurality of segments for the base portion of the HSM assembly; and
(b) vertically stacking the segments.

9. The method of claim 8, wherein the plurality of segments are formed in a single form.

10. The method of claim 8, wherein the first segment is poured and allowed to harden, and the second segment is poured on the hardened first segment.

11. The method of claim 9, wherein the second segment is allowed to harden, and the third segment is poured on the hardened second segment.

12. The method of claim 9, wherein the plurality of segments include bond breakers between adjacent segments in the form.

13. The method of claim 8, further comprising vertically attaching adjacent segments.

14. The method of claim 13 wherein the method does not include horizontally attaching adjacent segments.

15. The method of claim 8, wherein the base portion includes at least first and second segments.

16. The method of claim 8, wherein the base portion includes at least first, second, and third segments.

17. The method of claim 8, wherein adjacent segments are attached to one another using only a vertical attachment system.

18. The method of claim 8, wherein the plurality of segments are formed from reinforced concrete.

19. The method of claim 8, wherein the plurality of segments are substantially similar in at least one of size, shape, and weight.

20. The method of claim 8, wherein the plurality of segments are stacked using a single lifting fixture.
